(19) United States
(12) Patent Application Publication
(10) Pub. No.: US 2022/0008913 A1
(43) Pub. Date: Jan. 13, 2022

(54) OPTICALLY ACTUATED FLUID CONTROL FOR MICROFLUIDIC STRUCTURES

(71) Applicant: Jeffrey G. Manni, Burlington, MA (US)

(72) Inventor: Jeffrey G. Manni, Burlington, MA (US)

(21) Appl. No.: 17/359,637

(22) Filed: Jun. 27, 2021

Related U.S. Application Data
(60) Provisional application No. 63/045,080, filed on Jun. 27, 2020.

(51) Int. Cl. B01L 3/00; B01F 13/00

(52) U.S. Cl. CPC B01L 3/50273; B01L 3/502715; B01L 3/502738; B01F 13/0064; B01F 2215/0037; B01L 2300/0816; B01L 2400/0622; B01L 2400/0442; B01F 13/0079

(57) ABSTRACT

The invention is an apparatus for mixing and moving small fluid samples including a microfluidic chip with a fluid flow channel and an injection port, a channel light beam with a channel lens configured to converge a channel light beam and project a channel light beam focal spot into the fluid flow channel;

### FIELD OF THE INVENTION

The invention relates to methods and apparatuses for actuating and/or pumping liquids within microfluidic and nanofluidic devices.

### BACKGROUND OF THE INVENTION

The process of analyzing liquid samples containing chemical, biomolecular, and cellular species using micro total analysis systems (μTAS), “lab-on-a-chip,” or “microfluidic chips,” is a rapidly growing technology. These devices and systems incorporate micro- and nano-size channels, chambers, and fluid-related structures designed to manipulate and analyze biomolecules, cells, and nanoparticles, for example, that are present in a liquid-carrier medium. New methods are being developed for fabricating increasingly complex microfluidic chips having multiple layers, channels, and chambers. These complex microfluidic components require novel methods for precisely controlling liquid flow to enable full exploitation of new designs. In addition to the development of better micropumps, new designs and methods are needed for mixing of liquid flows within the microfluidic chip, and better “microvalves” are needed for controlling where and when flows can occur on the microfluidic chip.

Micropumps commonly used with micro-analysis chips include displacement pumps and dynamic pumps. Displacement pumps include reciprocating (diaphragm, piston), rotary, and aperiodic (pneumatic, phase-change, electrowetting, thermocapillary) pumps. Dynamic pumps, in which the driving force interacts directly with the liquid medium, include electro-osmotic, electrohydrodynamic, magnetohydrodynamic, and acoustic/ultrasonic pumps.

All of the above micropump technologies have their strengths and weaknesses. No single technology can be used in all situations. What is needed is a micropump technology that is useful in most common applications. The present invention results from the observation that none of the current micropump technologies involve the use of light energy, either directly or indirectly, to effect fluid pumping.

Liquid water has well-known absorption peaks that can be exploited to deliver energy into a water-based liquid medium in a highly localized or otherwise well-controlled fashion. As shown in FIG. 1, the main liquid-water absorption peaks occur at 2940 nm, 1920-1940 nm, 1440 nm, 1320-1340 nm, and 980 nm. However virtually any wavelength in the 2940 nm to 11,000 nm range has a sufficient level of absorption in liquid water to be useful in energy delivery. This absorption attribute may also be useful for other wavelengths, such as in the 980 to 2940 nm range, or at UV wavelengths shorter than about 300 nm. If the water-based liquid medium has an adequate concentration of absorbing atoms or molecules, then wavelengths corresponding to absorption peaks of the absorbing atoms or molecules present in the liquid medium may be used for similar applications.

Compact and low-cost lasers at many different wavelengths have become available in recent years, and can be utilized to deliver energy into a water-based liquid medium. These lasers include modulated continuous-wave and pulsed solid-state lasers (e.g., semiconductor diode lasers) operating at 980 nm, 1320 nm, 1440 nm, and at telecom wavelengths in the 1500-1600 nm range, as well as quantum cascade lasers, inter-band, and inter-sub-band lasers operating at 3000 to 10,000 nm wavelengths.

If the liquid medium includes atoms or molecules that absorb strongly at visible or UV wavelengths, then semiconductor laser diodes or LEDs that emit visible or UV wavelengths may be used. One- or two-dimensional arrays of semiconductor laser diodes or LEDs may be used if emitter spacing in the array is small enough to provide a desired level of microfluidic pumping control.

### BRIEF SUMMARY OF THE INVENTION

One object of the present invention is to provide a novel method of pumping liquids in microfluidic chips, and, in particular, a method that enables pumping to and from chambers, such as may be embedded in a multi-layer 3-D chip structure. Flow direction and volumetric flow rate may be controlled, for example, by controlling pulse energy, pulse rate, and where on the chip light energy is applied. Laser or light energy may be focused into a chamber embedded within a 3-D structure in such a way that liquid is pumped out of the embedded chamber, but without affecting liquid or material in layers above, below, or adjacent the embedded chamber.

Another object of the present invention is to provide a novel pumping method that enables a liquid droplet, a liquid sample, or a liquid “plug,” being manipulated in the chip to be followed as it moves through the chip. The laser or light beam may be moved in real time as needed to keep the liquid plug moving to where it is intended to be. As an example, the simultaneous applications of two appropriately positioned beam spots may force the liquid plug to enter one channel at a channel branch point, rather than an alternative channel, thereby eliminating the need for microvalves at the branch point. Alternatively, a one-dimensional or two-dimensional array of semiconductor laser diode or LED emitters may be selectively energized in space and time, as needed, to follow the liquid droplet or plug through the chip. This is achieved by placing the one-dimensional or two-dimensional array in near contact with the microfluidic array so that the radiation emitted from the semiconductor laser diode or LED emitters is accurately imaged onto, or otherwise projected onto, the microfluidic chip.

Another object of the present invention is to provide a pumping method that enables precise metering of liquid flows in microfluidic chips where required flow rates may typically be in the picoliter/sec, nanoliter/sec, or microliter/sec range. For a given light wavelength, pulse duration, and applied spot diameter, pulse energy may adjusted over a very wide range, e.g., six orders of magnitude or more, as needed to precisely control volumetric flow rates and total transferred liquid volumes.

Another object of the present invention is to provide a novel means for mixing liquids in microfluidic devices, and, in particular, to enable mixing in chambers that may be embedded in a multi-layer 3-D chip structure. Mixing may be controlled, for example, by controlling pulse energy, pulse rate, and focused spot location of the incident light energy. One possible mixing method may involve the use of high-peak-power pulsed laser energy to create micro-bubbles in the liquid, in addition to creating a pressure wave, as a way to enhance or accelerate mixing.

Another object of the present invention is to provide a pumping method that may work into high pressure gradients as are typical in microfluidic chips. This may be achieved by controlling laser emission parameters such as wavelength, pulse energy, pulse duration, pulse rate, and beam/exposure-spot diameter, for example.

Another object of the present invention is to provide increased flexibility for tailoring pumping and mixing methods to the specific liquids being manipulated. In particular, laser wavelength may be adjusted to control the strength of light absorption by the liquid, which, in turn, may affect the amount of pulse energy and peak power needed to produce the desired light-induced effect in the liquid, such as, for example, pressure wave, speed of the liquid plug through the channel, and bubble production.

Another object of the present invention is to reduce or eliminate “dead volume” at the chip-to-world interface and elsewhere on the chip, as dead volumes are often relatively large with existing microfluidic pumping methods.

Another object of the present invention is to provide a method for multipoint actuation as may be used to drive multiple flow channels simultaneously, for example, or to control flow direction at branching points, for example. Light energy may be divided into multiple beamlets to drive multiple channels. Alternatively, the laser beam may be configured as a line focus to drive multiple channels at the same time. Alternatively, a one- or two-dimensional array of semiconductor laser diodes or LEDs that is placed in near-contact with the microfluidic chip may be used to effect multipoint actuation by selectively actuating individually addressable light emitters. The selective actuation may be a function of coordinate position and/or time for each of the addressable light emitters.

Another object of the present invention is to provide new means for pumping and mixing that improve the design and fabrication flexibility of microfluidic devices, and that, in particular, are compatible with relatively common chip designs.

Other advantages and benefits of the present invention will become apparent in the discussion below. The foregoing general description and detailed descriptions below are intended only to be exemplary and explanatory and are not intended to be restrictive of the invention. The detailed descriptions of embodiments provided below are intended only to be exemplary and explanatory and are not intended to restrict the scope of the invention.

### BRIEF DESCRIPTION OF THE DRAWINGS

The foregoing aspects, uses, and advantages of the present invention will be more fully appreciated as the same becomes better understood from the following detailed description of the present invention when viewed in conjunction with the accompanying figures, in which:

FIG. 1 is a graph of main liquid-water absorption peaks, in accordance with the prior art;

FIG. 2 is a diagrammatical illustration of laser energy focused into a fluid chamber of a microfluidic chip to force fluid flow into a fluid flow channel, in accordance with an aspect of the present invention;

FIG. 3 is a diagrammatical illustration of a laser energy focused into an embedded chamber of a 3-D microfluidic chip without affecting fluid present in adjacent fluid flow channels, in accordance with an aspect of the present invention;

FIG. 4 is a diagrammatical illustration of a laser beam set up to move a liquid sample through a fluid flow channel of a microfluidic chip, in accordance with an aspect of the present invention;

FIG. 5 is a diagrammatical illustration of the laser beam of FIG. 4 showing that the liquid sample has been displaced along the fluid flow channel;

FIG. 6 is a diagrammatical illustration of the laser beam of FIG. 5 showing that the liquid sample has been further displaced along the fluid flow channel;

FIG. 7 is a diagrammatical illustration of two laser beams used to control flow direction of a fluid sample at a channel branch point in a microfluidic chip so as to serve as a microvalve, in accordance with an aspect of the present invention;

FIG. 8 is a diagrammatical illustration of the microfluidic chip of FIG. 7 showing the fluid sample diverted into an upper fluid flow channel;

FIG. 9 is a diagrammatical illustration of the microfluidic chip of FIG. 7 showing the fluid sample diverted into a lower fluid flow channel;

FIG. 10 is a diagrammatical illustration of fluid flow in a microfluidic chip controlled by transport focus regions used to drive fluid flow in multiple channels, in accordance with an aspect of the present invention;

FIG. 11 is a diagrammatical isometric illustration of the microfluidic chip of FIG. 10;

FIG. 12 is a diagrammatical illustration of fluid flow in a microfluidic chip with individually controlled transport focus regions used to drive fluid flow in multiple channels, in accordance with an aspect of the present invention;

FIG. 13 is a diagrammatical isometric illustration of the microfluidic chip of FIG. 12;

FIG. 14 is a diagrammatical illustration of line-focus actuation using an elliptical light beam spot to spatially extend over more than one fluid flow channel, in accordance with an aspect of the present invention;

FIG. 15 is a diagrammatical illustration of laser or light beams used to effect fluid mixing in a chamber or in a fluid flow channel, in accordance with an aspect of the present invention; and,

FIG. 16 is a diagrammatical illustration of fluid mixing in a chamber or in a fluid flow channel using laser-induced plasma with a shock wave to improve mixing, in accordance with an aspect of the present invention.

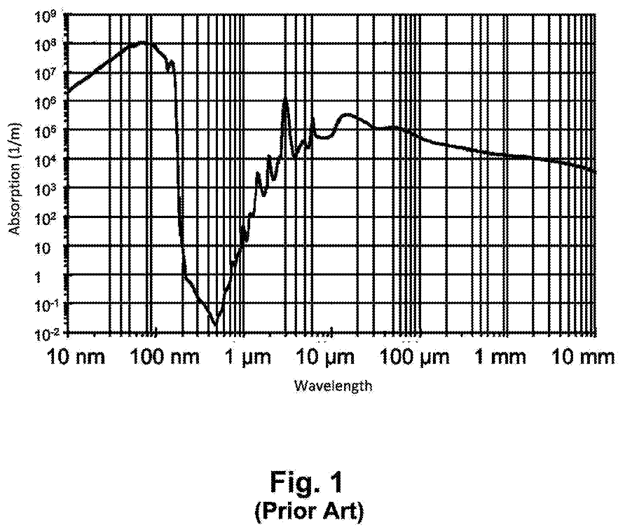

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention. Moreover, the detailed descriptions of embodiments provided below are intended only to be exemplary and explanatory and are not intended to be restrictive of the invention.

The present invention incorporates pulsed laser light, time-modulated continuous-wave laser light, or non-laser light having a wavelength that is strongly absorbed by a liquid medium itself or by molecular constituents dissolved in the liquid medium. Absorption of pulsed light energy beams creates a pressure wave in the liquid medium that forces the liquid to move through a microfluidic device. The timing and location of the applied light energy beams, producing exposure spots, controls how and when the liquid medium moves through various sections of a microfluidic device.

In addition to using direct absorption of light, the present invention may also employ the generation of a laser-induced plasma (LIP) in the liquid medium as a means to create a useful pressure wave. In general, generation of an LIP requires the use of a high-peak-power laser that can be focused to a beam diameter small enough that the electric field in the focused laser beam can “break down” the liquid medium as needed to create a plasma. Once created, the plasma strongly absorbs laser energy to create a pressure wave or shock wave in the liquid medium.

As understood in the present specification, the term “microfluidic” is used to indicate devices having sub-mm, micron, sub-micron, and nanometer-size channels, chambers, and other physical features. As described above, the main liquid-water absorption peaks occur at 2940 nm, 1920-1940 nm, 1440 nm, 1320-1340 nm, and 980 nm. However virtually any wavelength in the 2940 nm to 11000 nm range has strong enough absorption in liquid water to be useful in the present invention. This also applies to wavelengths in the 980 to 2940 nm range, and to UV wavelengths shorter than about 300 nm.

The phrase “strongly absorbed” is used herein to mean that, considering the applied wavelength, pulse energy, pulse duration, and beam spot diameter, absorption of laser or light energy is strong enough to create a pressure wave in the liquid medium that can be used to do something useful, such as, for example, induce fluid movement through a channel or into a chamber, or to mix liquids, and is not intended to be restrictive on the invention.

Regarding the use of the term “pulsed,” a laser or light pulse has an appropriate pulse duration and pulse energy (enough peak power), that is modulated in time by some means as needed, considering the laser wavelength and how strongly it is absorbed in the liquid medium, to create a useful pressure wave in the liquid, and is not intended to be restrictive on the invention. Accordingly, the term “pulsed laser” as used herein means a continuous-wave laser, or a light-emitting diode (LED), that has its emitted power modulated in time in a way that is useful for creating pressure waves in microfluidic devices.

The present invention employs pulsed or time-modulated light or laser emission having a wavelength that is strongly absorbed by the liquid medium itself, or by molecular constituents dissolved in the liquid medium. Direct absorption of pulsed/modulated light energy in the liquid creates a pressure wave in the liquid medium that forces a liquid to move through (i.e., pumped through) the microfluidic device. The timing and location of applied pulsed light energy controls how, when, and where liquids are moved through various sections of the microfluidic device. The invention is expected to be especially useful for manipulation of flows in three-dimensional (3-D) microfluidic devices since laser or light energy may be focused within specific layers of the device in a controlled fashion.

The invention relates to the use of light energy to optically actuate and control the flow of liquid in a microfluidic chip device, as are typically used for micro-analysis or micro-synthesis of chemical or biochemical species in a liquid medium. The invention employs direct absorption or other direct interaction of light with the liquid medium, or a species dissolved in the liquid medium, as a means to create pressure waves in the liquid and implement specific microfluidic tasks such as volumetric flow control, flow branching and direction, and fluid mixing. Various exemplary embodiments of the present invention are described in the specification below, each with reference to the appropriate Figure(s). It should be understood that, for clarity of illustration, not all disclosed microfluidic features are shown to the same scale, or in correct proportion to one another, and should not be taken as literal illustrations of actual microfluidic and nanofluidic devices. In addition, although some devices are presented with straight edges, angular corners, and flat surfaces, present-day manufacturing methods can produce these components having, rounded edges, corner fillets, and curved surfaces.

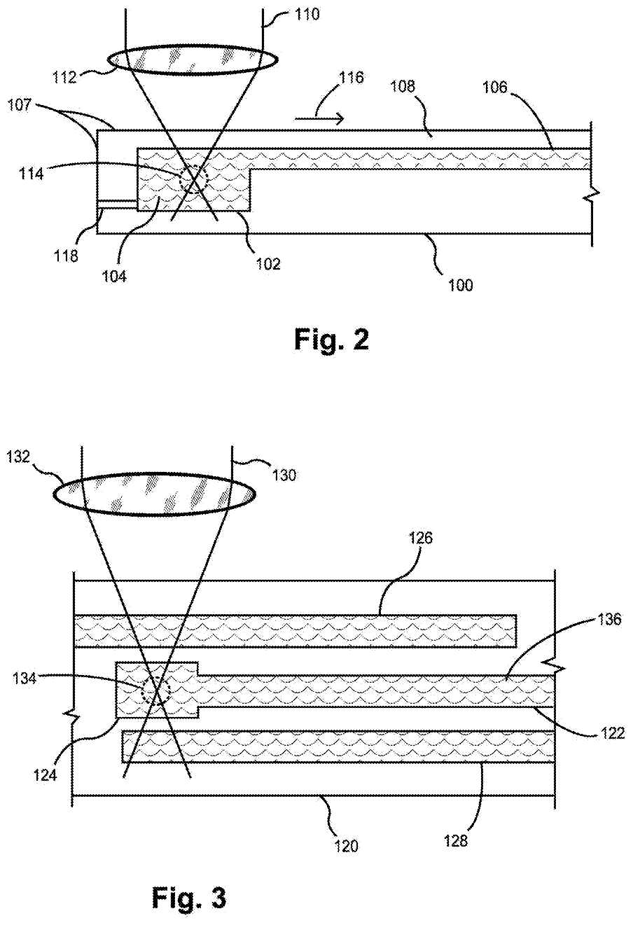

In accordance with an aspect of the present invention, there is shown in FIG. 2, a light beam 110 used to control fluid flow in a microfluidic chip 100, here shown in a side view. The microfluidic chip 100 may be fabricated from an optically transparent substrate 108, such as polydimethylsiloxane (PMMS), poly(methyl methacrylate) (PMMA), polycarbonate (PC), and polystyrene (PS). The microfluidic chip 100 is a two-dimensional (2-D) structure enclosing one or more fluid chambers and one or more fluid flow channels. In the configuration shown, a microfluidic chamber 102 provides a supply of liquid medium 104 to a fluid flow channel 106. An injection port 118, or similar opening in an outer surface 107 of the substrate 108, may be provided to insert the liquid medium 104 into the microfluidic chamber 102.

A lens 112 is used to converge the light beam 110 to a light beam focal spot 114, or focal region, in the microfluidic chamber 102 or in another specified fluid volume (not shown) in the microfluidic chip 100. The thermal energy in the light beam 110, which may be a coherent light laser beam, causes the liquid medium 104 to flow out of the microfluidic chamber 102, as indicated by an arrow 116, and through the fluid flow channel 106. In accordance with the liquid-water absorption parameters described above, if water is a significant or substantial component of the liquid medium 104, the emission frequency of the light beam 110 is specified to be a wavelength of from 980 nm to 11000 nm and, preferably, a wavelength at or near one or more of peak wavelengths of: 980 nm, 1320-1340 nm, 1440 nm, 1920-1940 nm, and 2940 nm.

The lens 112 may not be required for producing the light beam focal spot 114 if the size of the light beam 110 is small enough to spatially overlap a desired portion of the microfluidic chamber 102, without affecting other regions of the microfluidic chip 100, or if the desired pressure wave can be induced without focusing the light beam 110. The volumetric flow rate of the liquid medium 104 may be controlled by adjusting applied energy, peak power, pulse rate, and/or other parameters, of the light beam 110. The total flow volume may be controlled by controlling the total thermal energy applied via the light beam focal spot 114.

There is shown in FIG. 3 a side view of a multilayer microfluidic chip 120 configured as a 3-D structure having two or more microfluidic chambers and one or more flow channels embedded in a multilayer structure. A chamber light beam 130 may be focused by a chamber lens 132 into an embedded fluid source chamber 124 in order to force a liquid medium 136, i.e., a liquid sample, through an embedded fluid flow channel 122. Advantageously, fluid flow is induced in the embedded fluid flow channel 122 without affecting fluid in either an overlying fluid flow channel 126 or an underlying fluid flow channel 128. This is accomplished by focusing the chamber light beam 130 such that beam intensity is high (i.e., the beam size is small) only in a light beam focal spot 134. Accordingly, the chamber light beam 130 is dimensionally larger in the overlying fluid flow channel 124 and in the underlying fluid flow channel 128 by which the intensity of the laser or light beam 130 is too low to induce a significant pressure wave, or other adverse effect, affecting fluid flow in the overlying fluid flow channel 124 or in the underlying fluid flow channel 128.

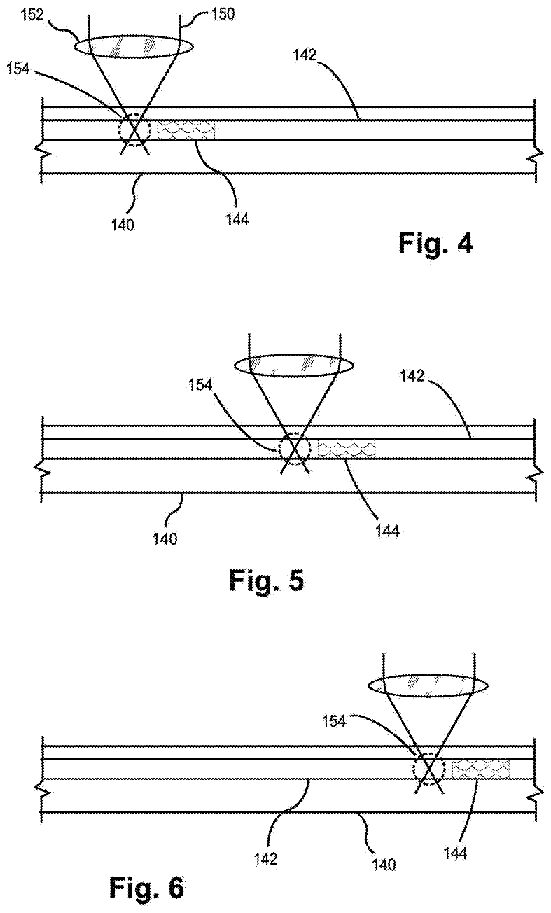

FIG. 4 is a diagrammatical side view of a single-layer microfluidic chip 140 with a fluid flow channel 142. A fluid sample 144 is being transported through the fluid flow channel 142 by a channel light beam focal spot 154 produced by a channel light beam 150 and a channel lens 152. The channel light beam focal spot 154 can be moved using a scanning mirror (not shown), as is well-known in the relevant art. In an alternative method, the channel light beam focal spot 154 can remain fixed while the microfluidic chip 140 is moved relative to the channel light beam focal spot 154 using a scanning table (not shown). FIGS. 5 and 6 show progression of the fluid sample 144 through the fluid flow channel 142 as the microfluidic chip 140 and channel light beam focal spot 154 are moved relative to one another.

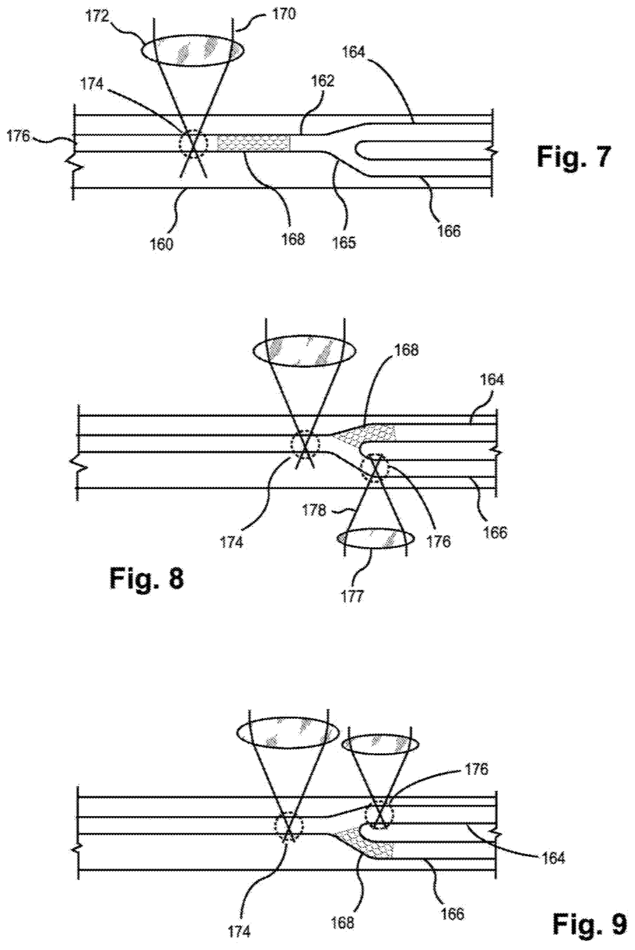

FIG. 7 is a diagrammatical side view of a multi-layer microfluidic chip 160 with an injection port opening 176 at a fluid flow channel 162 that leads to a branch point transition channel 165 in fluid communication with a right fluid flow channel 164 and with a left fluid flow channel 166. A guided transport light beam focal spot 174 produced by a transport light beam 170 and a transport lens 172 functions to move a fluid sample 168 along the fluid flow channel 162. At the same time, a selector light beam focal spot 176, produced by a selector light beam 178, shown in FIG. 8, is directed into the right fluid flow channel 166 to block the fluid sample 168 from entering the right fluid flow channel 166, thus to enable the transport light beam focal spot 174 to selectively move the fluid sample 168 into the left fluid flow channel 164. Alternatively, when the selector light beam focal spot 176 is placed in the right fluid flow channel 166, as shown in FIG. 9, the fluid sample 168 is then moved by the transport light beam focal spot 174 into the left fluid flow channel 164. In the configuration shown, the selector light beam 176 functions as a microvalve that directs the fluid sample 168 to either the left fluid flow channel 164 or the right fluid flow channel 166.

Another method of controlling the flow of fluid samples alternative is to place a 1-D emitter array or a 2-D emitter array of individually-addressable light emitters in near-contact with a microfluidic chip, and to selectively activate, in space and time, exposure characteristics of the emitter array of individually-addressable light emitters such that a pressure wave is created in a specified region of the fluid to effect fluid motion relative to the microfluidic chip. The light emitters in the emitter array may be edge-emitting semiconductor diode lasers, vertical-cavity semiconductor diode lasers, light-emitting diodes (LEDs), or similar light-emitting sources that lend themselves to packaging in a reasonably dense array format. Depending on the light-emitter design, and on application needs, micro-optic arrays may or may not be included in order to spatially collimate the emissions of corresponding individual light emitters. Arrays of semiconductor-based light emitters are available in the present state of the art, and design improvements will be available in the foreseeable future, at many different wavelengths that may be advantageous for use in the present invention.

Continuing the process of controlling fluid sample flow, the constantly moving laser or light beam focal spot would follow the pressure wave, and the pressure wave would force the fluid sample through a desired fluid flow channel. Advantageously, the light emitter array is positioned proximate the microfluidic array so that the radiation emitted from the individually-addressable light emitters is accurately imaged onto, or otherwise projected onto, selected fluid flow channels in the microfluidic chip.

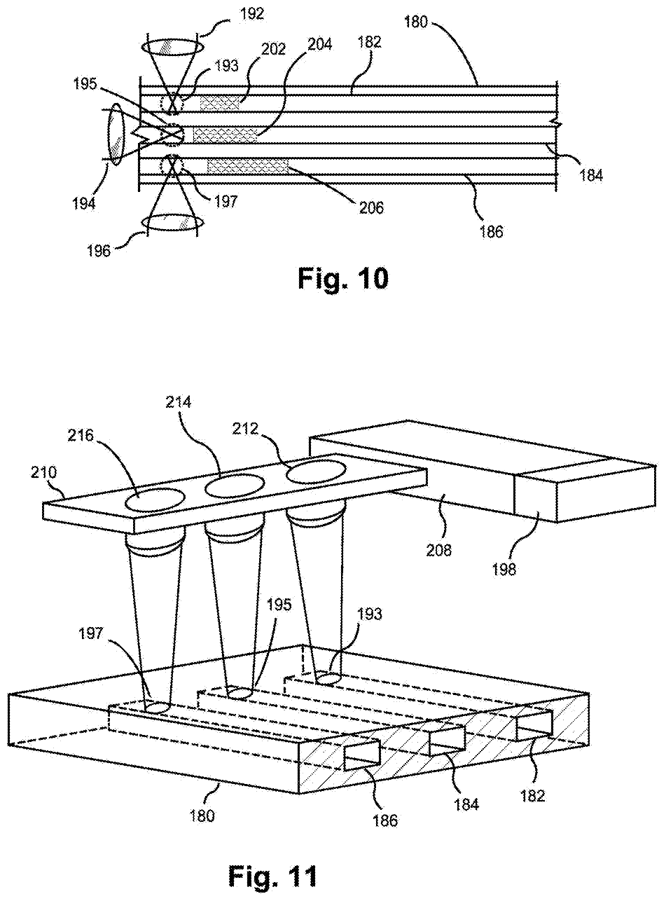

In an exemplary embodiment, shown in FIGS. 10 and 11, fluid flow in a microfluidic chip 180 is controlled by transport light beam focus spots used to drive fluid flow in multiple channels, either simultaneously or sequentially in time. This procedure readily lends itself to the use of semiconductor emitters having different combinations of wavelengths, energy level, exposure duration, as may prove advantageous in various applications. In the particular configuration shown, the microfluidic chip 180 is in the shape of a rectangular parallelepiped, as is commonly used in the present state of the art. The microfluidic chips 100, 120, 140, and 160, shown above, and 220, 280, 300, and 310, shown below, are likewise in the shape of rectangular parallelepipeds. In the microfluidic chip 180, a first fluid sample 202 is transported through a first fluid flow channel 182 by a first moveable transport light beam focal spot 193. Similarly, a second fluid sample 204 is transported through a second fluid flow channel 184 by a second moveable transport light beam focal spot 195, and a third fluid sample 206 is transported through a third fluid flow channel 186 by a third moveable transport light beam focal spot 197.

The transport focus regions 193, 195, 197 are produced by a 1-D array 200 of individually-addressable semiconductor diode or LED emitters 212, 214, 216, that are moved and positioned relative to the microfluidic chip 180 by a scanning table 208. In response to movement of the scanning table 208, the fluid samples 202, 204, 206 are transported in the respective fluid flow channels 182, 184, 186, either simultaneously or sequentially in time. A scanning controller 198 controls movement of the scanning table 208 and selectively activates individual emitters 212, 214, 216 that are positioned in near contact with the respective fluid flow channels 182, 184, 186.

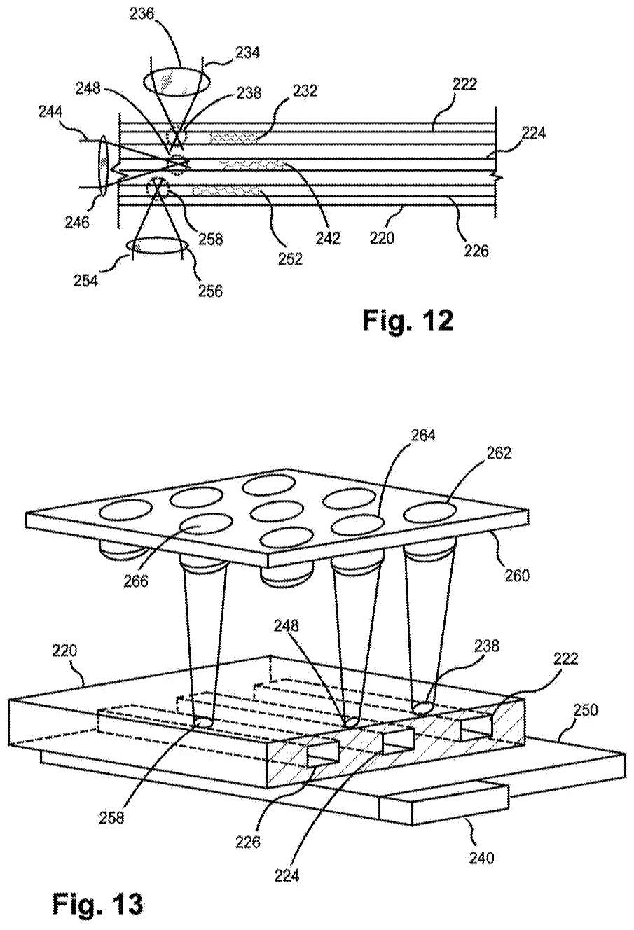

An exemplary embodiment incorporating a 2-D array of semiconductor emitters is shown in FIGS. 12 and 13. Fluid flow in a microfluidic chip 220 is controlled by individually controlled transport light beam focus spots used to drive fluid flow in multiple channels, either simultaneously or sequentially in time. A 2-D semiconductor emitter array 260 of individually-addressable semiconductor emitters may include one or more of edge-emitting semiconductor diode lasers, vertical-cavity semiconductor diode lasers, light-emitting diodes (LEDs), or similar light-emitting sources that lend themselves to packaging in a reasonably dense 2-D array format. The semiconductor emitters can provide different combinations of wavelengths, energy levels, and exposure durations, depending on the particular application required. Micro-optic arrays may or may not be included in order to spatially collimate the emissions of the individual semiconductor emitters.

In the particular configuration shown, a first fluid sample 232 is transported through a first fluid flow channel 222 by a first transport light beam focal spot 238. Similarly, a second fluid sample 242 is transported through a second fluid flow channel 224 by a second transport light beam focal spot 248, and a third fluid sample 252 is transported through a third fluid flow channel 226 by a third transport light beam focal spot 258. The transport focus regions 238, 248, 258 are produced by respective semiconductor emitters 262, 264, 266, that are individually, selectively activated in space and time as needed to move, direct, or mix the transport light beam focus spots 238, 248, 258. The microfluidic chip 220 is moved and positioned relative to the semiconductor emitter array 260 by a scanning table 250 to precisely position the transport focus regions 238, 248, 258 on the microfluidic chip 220. A scanning controller 240 selectively activates individual emitters 262, 264, 266 and determines the position of the scanning table 250 in coordination with the activation of selective emitters such that the fluid samples 232, 242, 252 are transported in the respective fluid flow channels 222, 224, 226, either simultaneously or sequentially in time.

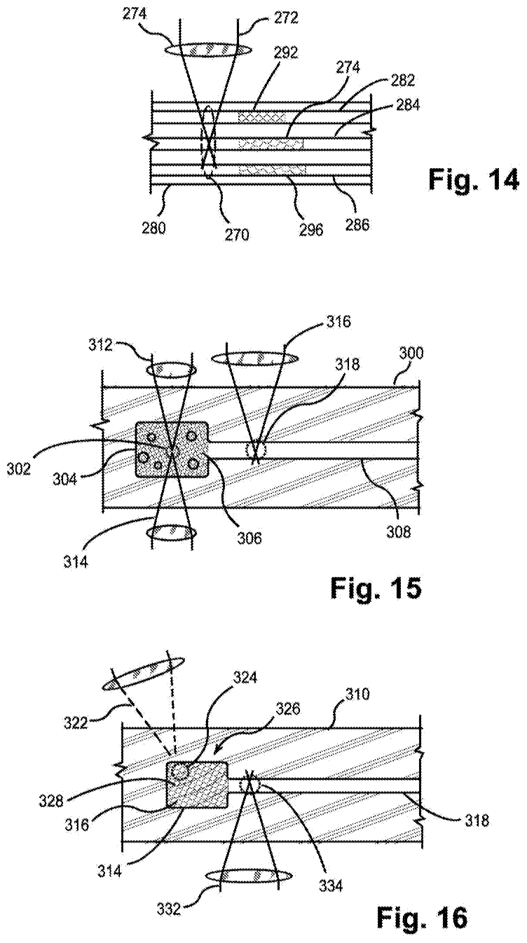

There is shown in FIG. 14 an example of line-focus actuation wherein a light beam 272 shaped by a lens 274 into a single, elliptical light beam focal spot 270. The elliptical light beam focal spot 270 has a line-shaped focus so as to spatially extend over more than one fluid flow channel. In the configuration shown, when the elliptical light beam focal spot 270 is moved along adjacent fluid flow channels 282, 284, and 286 of a microfluidic chip 280, a first fluid sample 292, a second fluid sample 294, and a third fluid sample 296 are moved in unison within respective fluid flow channels 282, 284, and 286.

In an exemplary embodiment, one or more laser or light beams may be used to effect fluid mixing in a chamber or in a fluid flow channel. In the example of FIG. 15, a microfluidic chip 300 includes a microfluidic mixing chamber 304 containing a liquid medium 306, and connected to a fluid flow channel 308. A first laser beam 312 and a second laser beam 314 are both directed into a single volumetric region 302 in the microfluidic mixing chamber 304. Pulse energy, peak power, wavelength, spatial distribution of energy within the light beams, exposure times, and/or other aspects of the applied laser energy exposures may be adjusted to effect a desired degree of mixing of fluid components within the microfluidic mixing chamber 304. Light exposure parameters may also be adjusted to generate micro-bubbles within the fluid volume as a way to accelerate or otherwise improve mixing in the microfluidic mixing chamber 304. A blocking light beam 316 forms a blocking light beam focal spot 318 in the fluid flow channel 308 to confine the liquid medium 306 to the microfluidic mixing chamber 304.

In another method of mixing a fluid sample, shown in FIG. 16, a microfluidic chip 310 includes a microfluidic mixing chamber 314 containing a liquid medium 316, where the microfluidic mixing chamber 314 is connected to a fluid flow channel 318. A high-peak-power focused laser beam 322 has been modified to specified light exposure parameters such that the diameter of a laser focal spot 324 is small enough to produce an electric field in the focused laser beam to break down the liquid medium 316 and create a plasma 326. Once created, the plasma 326 strongly absorbs laser energy to create a pressure wave 328, or shock wave, in the liquid medium 316 to improve mixing. The pressure wave may be created by direct absorption of light from the mixing light beam laser focal spot 324, generation of the induced plasma 326, or by direct absorption of temporally pulsed or modulated light emission in the liquid medium 316. A blocking light beam 332 projects a blocking light beam focal spot 334 into the fluid flow channel 318 so that the liquid medium 316 is restrained from leaving the mixing chamber 314 during the mixing process.

It is to be understood that the description herein is only exemplary of the invention, and is intended to provide an overview for the understanding of the nature and character of the disclosed methods and apparatuses for moving and mixing liquids within microfluidic and nanofluidic devices. The accompanying drawings are included to provide a further understanding of various aspects and embodiments of the devices of the invention which, together with their description and claims, serve to explain the principles and operation of the invention.

What is claimed is:

1. An apparatus suitable for mixing and moving fluid samples of picoliter volumes, nanoliter volumes, and microliter volumes, said apparatus comprising:
a substrate in the shape of a rectangular parallelepiped forming a microfluidic chip;
a fluid flow channel enclosed within said substrate, said fluid flow channel including an injection port opening in an outer surface of said substrate, said injection port opening configured to admit a specified volume of a selected fluid sample into said fluid flow channel;
a channel light beam of a specified wavelength proximate said substrate; and
a channel lens positioned between said channel light beam and said fluid flow channel, said channel lens configured to converge said channel light beam and project a channel light beam focal spot into said fluid flow channel;
whereby a movement of said channel light beam focal spot relative to said fluid flow channel induces a corresponding movement of said selected fluid sample through said fluid flow channel.

2. The apparatus of claim 1 further comprising a scanning table configured to move said microfluidic chip and said channel lens relative to one another.

3. The apparatus of claim 1 further comprising:
a branch point transition channel in fluid communication with said fluid flow channel;
a right fluid flow channel in fluid communication with said branch point transition channel;
a left fluid flow channel in fluid communication with said branch point transition channel; and,
a selector lens disposed between a selector light beam and said branch point transition channel so as to converge said selector light beam and position a selector light beam focal spot in either said right fluid flow channel or in said left fluid flow channel;
whereby said position of said selector light beam focal spot determines movement of said selected fluid sample into either said right fluid flow channel or said left fluid flow channel.

4. The apparatus of claim 1 further comprising:
a mixing chamber in said substrate, said mixing chamber in fluid communication with said fluid flow channel;
a mixing light beam of a mixing wavelength proximate a mixing fluid sample in said mixing chamber; and
a mixing lens positioned between said mixing light beam and said mixing chamber, said mixing lens configured to converge said mixing light beam and project a mixing light beam focal spot into said mixing chamber;
whereby projection of said channel light beam focal spot into said fluid flow channel serves to confine said liquid medium to said microfluidic mixing chamber.

5. The apparatus of claim 4 wherein said mixing light beam focal spot comprises a specified light frequency such that said mixing light beam focal spot interacts directly with said mixing fluid sample to generate a pressure wave within said mixing fluid sample strong enough to actuate fluid flow, to actuate fluid mixing, and/or to prevent fluid flow in a specified direction.

6. The apparatus of claim 5 wherein said pressure wave is created by direct absorption of light, from said mixing light beam focal spot, by said mixing fluid sample.

7. The apparatus of claim 5 wherein said pressure wave is created by generation of a laser-induced plasma in said mixing fluid sample.

8. The apparatus of claim 5 wherein said pressure wave is created by direct absorption of temporally pulsed or modulated light emission by said mixing fluid sample.

9. The apparatus of claim 1 further comprising:
a plurality of fluid samples in respective fluid flow channels;
an array of individually-addressable light emitters, each said individually-addressable light emitter producing light of a frequency specified to interact directly with one of a corresponding said fluid sample, said array of individually-addressable light emitters placed in near contact with said microfluidic chip to generate a pressure wave within a specified said fluid sample, said pressure wave producing at least one of fluid flow actuation in a selected direction, fluid mixing in a specified location, or fluid flow attenuation in a specified direction;
a control unit functioning to selectively activate in space and time exposure characteristics of said array of individually-addressable light emitters such that a pressure wave is created in a specified region of said plurality of fluid samples to effect fluid motion relative to said microfluidic chip, and
a scanning table functioning to position at least one of said individually-addressable light emitters proximate said specified region of said plurality of fluid samples so as to accomplish a specific microfluidic pumping task.

10. The apparatus of claim 1 further comprising:
a second fluid flow channel enclosed within said substrate;
a second channel lens positioned between a second channel light beam of a second specified wavelength and said second fluid flow channel, said second channel lens configured to converge said second channel light beam and project a second channel light beam focal spot into said second fluid flow channel;
a third fluid flow channel enclosed within said substrate; and,
a third channel lens positioned between a third channel light beam of a third specified wavelength and said third fluid flow channel, said third channel lens configured to converge said third channel light beam and project a third channel light beam focal spot into said third fluid flow channel;
whereby a movement of a second fluid sample in said second fluid flow channel is independent of a movement of a third fluid sample in said third fluid flow channel.

11. The apparatus of claim 10 further comprising a scanning table configured to move said substrate and said second channel lens relative to one another.

12. An apparatus suitable for mixing and moving fluid samples of picoliter volumes, nanoliter volumes, and microliter volumes, said apparatus comprising:
a substrate in the shape of a rectangular parallelepiped forming a microfluidic chip;
a fluid flow channel enclosed within said substrate, said fluid flow channel including an injection port opening in an outer surface of said substrate configured to admit a specified volume of a selected fluid sample into said fluid flow channel;
a channel light beam of a specified wavelength proximate said substrate;
a channel lens positioned between said channel light beam and said fluid flow channel, said channel lens configured to converge said channel light beam and project a channel light beam focal spot into said fluid flow channel;
a mixing chamber in said substrate, said mixing chamber in fluid communication with said fluid flow channel;
a mixing light beam of a mixing wavelength proximate a mixing fluid sample in said mixing chamber; and
a mixing lens positioned between said mixing light beam and said mixing chamber, said mixing lens configured to converge said mixing light beam and project a mixing light beam focal spot into said mixing chamber.

13. A method of mixing and moving fluid samples of picoliter volumes, nanoliter volumes, and microliter volumes, said method comprising the steps of:
providing a substrate in the shape of a rectangular parallelepiped so as to form a microfluidic chip;
providing a fluid flow channel within said microfluidic chip, said fluid flow channel including an injection port opening in an outer surface of said microfluidic chip, said injection port opening configured to admit a specified volume of a selected fluid sample into said fluid flow channel;
providing a channel light beam of a specified wavelength proximate said microfluidic chip; and
positioning a channel lens between said channel light beam and said fluid flow channel, said channel lens configured to converge said channel light beam and project a channel light beam focal spot into said fluid flow channel;
whereby a movement of said channel light beam focal spot relative to said fluid flow channel induces a corresponding movement of said selected fluid sample through said fluid flow channel.

14. The method of claim 13 further comprising the steps of:
providing a second fluid flow channel within said microfluidic chip, said second fluid flow channel including a second opening in said outer surface of said microfluidic chip configured to admit a second specified volume of a second selected fluid sample into said second fluid flow channel;
providing a second channel light beam of a second specified wavelength proximate said microfluidic chip; and
positioning a second channel lens between said second channel light beam and said second fluid flow channel, said second channel lens configured to converge said second channel light beam and project a second channel light beam focal spot into said second fluid flow channel;

15. The method of claim 13 further comprising the step of: providing a scanning table configured to move said microfluidic chip and said second channel lens relative to one another.
